(19) United States
(12) Patent Application Publication
(10) Pub. No.: US 2004/0122769 A1
(43) Pub. Date: Jun. 24, 2004

(54) Method and apparatus for facilitating a payment from an account

(76) Inventors: Paul Bailo, Trumball, CT (US); Kathy M. Vogt, Fairfield, CT (US); Harold J. Berquist III, Bayside, NY (US); Brian M. Gunn, New Fairfield, CT (US); Woody Ladd, Rye, NY (US); Robert E. Muckle, Wolcott, CT (US)

Correspondence Address: BUCKLEY, MASCHOFF, TALWALKAR LLC, 5 ELM STREET, NEW CANAAN, CT, 06840, US

(21) Appl. No.: 10/323,468

(22) Filed: Dec. 19, 2002

(51) Int. Cl. G06F 17/60

(52) U.S. Cl. 705/42; 705/40; 705/39

(57) ABSTRACT

A system, method, apparatus, means, and computer program code for facilitating payment from an account. According to some embodiments of the present invention, a party or device may receive information indicative of a first account (e.g., a checking account) associated with an account holder. The party or device may then determine if the account holder has used the first account in the past (or within a designated time period) to make a payment to another account, another payee, etc. The party or device may then facilitate the actual monetary transaction or provide information regarding the scheduled payment to another party or entity that may facilitate the actual monetary transaction.

### FIELD OF THE INVENTION

The present invention relates to methods, means, apparatus, and computer code for facilitating a payment from an account.

### BACKGROUND OF THE INVENTION

In order to process payments quickly, or to enable account holders to make payments easily and conveniently online, merchants, credit card issuers, and other parties may want to facilitate payment by an account holder electronically or to allow an account holder to schedule a payment from an account to an another account associated with the account holder, another payee, etc. For example, a credit card issuer may want to allow a credit card holder to make a payment towards the balance of the credit card account from a checking account also used by or otherwise associated with the card holder. As another example, a merchant may want to allow a private label card holder to make a payment to the merchant from a checking account.

However, company, state, and federal rules, policies, conventions or regulations may require an oral verification that an account holder wishes to make a payment from a specific account. In addition, if he payment is being made from a checking account, such rules, policies, etc. may require that the account holder provide a blank and voided check in order to obtain the necessary account information (e.g., account number, ABA number) to facilitate the payment. Rule or policy changes may enable account holders to make payments from an account without having to provide oral verification. In such a situation, however, it still may be helpful to determine if an account holder is using an account previously used by the account holder to make a payment.

It would be advantageous to provide a method, means, computer code, and apparatus that facilitated payment by an account holder from an account associated with the account holder to another account, a designated payee, or other party.

### SUMMARY OF THE INVENTION

Embodiments of the present invention provide a system, method, apparatus, means, and computer program code for facilitating a payment from an account. According to some embodiments of the present invention, a party or device may receive information indicative of a first account (e.g., a checking account) associated with an account holder. The party or device may receive the information direction or indirectly from the account holder (e.g., the account holder may provide the information via a Web site), from a database, as part of an email message or other communication, etc. The party or device may then determine if the account holder has used the first account in the past (or within a designated time period) to make a payment to another account, a designated payee, etc. For example, the party or device may determine if the account holder has used a checking account to make a payment towards a credit card account's balance within the previous six months. If the answer is “yes”, the party or device may then schedule a new payment from the checking account to the credit card account. The party or device may then facilitate the actual monetary transaction or provide information regarding the scheduled payment to another party or entity that may facilitate the actual monetary transaction.

Additional objects, advantages, and novel features of the invention shall be set forth in part in the description that follows, and in part will become apparent to those skilled in the art upon examination of the following or may be learned by the practice of the invention.

According to some embodiments of the present invention, a method for facilitating payment may include receiving data indicative of a first financial account associated with an account holder; determining if the first financial account has previously been used to make a payment to a second financial account, the second financial account being associated with the account holder; and scheduling a payment from the first financial account to the second financial account if the first financial account has previously been used to make a payment to a second financial account. In some other embodiments, a method for facilitating payment may include receiving data indicative of an account holder making a first payment from a first financial account to a second financial account, the first financial account and the second financial account being associated with the account holder; receiving data indicative of a desire by the account holder to make a new payment from the first financial account to the second financial account; and scheduling the new payment from the first financial account to the second financial account. In some additional embodiments, a method for facilitating a payment may include receiving a payment by an account holder, the payment being drawn from a checking account associated with the account holder; determining from the payment an identifier indicative of the checking account; receiving data from the account holder indicative of a desire by the account holder to make a new payment from the checking account and data indicative of the identifier; and scheduling the new payment from the first account. In some further embodiments, a method for facilitating a payment may include receiving a payment by an account holder, the payment being drawn from a checking account associated with the account holder; determining from the payment an identifier indicative of the checking account; receiving data from the account holder indicative of a desire by the account holder to make a new payment from the checking account and data indicative of the identifier; and scheduling the new payment from the first account.

According to some embodiments of the present invention, a system for facilitating a payment may include a memory; a communication port; and a processor connected to the memory and the communication port, the processor being operative to receive data indicative of a first financial account associated with an account holder; determine if the first financial account has previously been used to make a payment to a second financial account, the second financial account being associated with the account holder; and schedule a payment from the first financial account to the second financial account if the first financial account has previously been used to make a payment to a second financial account. In some other embodiments, a system for facilitating a payment may include a memory; a communication port; and a processor connected to the memory and the communication port, the processor being operative to receive data indicative of an account holder making a first payment from a first financial account to a second financial account, the first financial account and the second financial account being associated with the account holder; receive data indicative of a desire by the account holder to make a new payment from the first financial account to the second financial account; and schedule the new payment from the first financial account to the second financial account. In some additional embodiments, a system for facilitating a payment may include a memory; a communication port; and a processor connected to the memory and the communication port, the processor being operative to receive a payment by an account holder, the payment being drawn from a checking account associated with the account holder; determine from the payment an identifier indicative of the checking account; receive data from the account holder indicative of a desire by the account holder to make a new payment from the checking account and data indicative of the identifier; and schedule the new payment from the first account. In some further embodiments, a system for facilitating a payment may include a memory; a communication port; and a processor connected to the memory and the communication port, the processor being operative to receive a payment by an account holder, the payment being drawn from a checking account associated with the account holder; determine from the payment an identifier indicative of the checking account; receive data from the account holder indicative of a desire by the account holder to make a new payment from the checking account and data indicative of the identifier; and schedule the new payment from the first account.

In some embodiments of the present invention, a computer program product in a computer readable medium for facilitating a payment may include first instructions for obtaining data indicative of a first financial account associated with an account holder; second instructions for identifying if the first financial account has previously been used to make a payment to a second financial account, the second financial account being associated with the account holder; and third instructions for scheduling a payment from the first financial account to the second financial account if the first financial account has previously been used to make a payment to a second financial account. In some other embodiments, a computer program product in a computer readable medium for facilitating a payment may include first instructions for obtaining data indicative of an account holder making a first payment from a first financial account to a second financial account, the first financial account and the second financial account being associated with the account holder; second instructions for obtaining data indicative of a desire by the account holder to make a new payment from the first financial account to the second financial account; and third instructions for scheduling the new payment from the first financial account to the second financial account. In some additional embodiments, a computer program product in a computer readable medium for facilitating a payment may include first instructions for obtaining a payment by an account holder, the payment being drawn from a checking account associated with the account holder; second instructions for identifying from the payment an identifier indicative of the checking account; third instructions for obtaining data from the account holder indicative of a desire by the account holder to make a new payment from the checking account and data indicative of the identifier; and fourth instructions for scheduling the new payment from the first account. In some further embodiments, a computer program product in a computer readable medium for facilitating a payment may include first instructions for obtaining a payment by an account holder, the payment being drawn from a checking account associated with the account holder; second instructions for identifying from the payment an identifier indicative of the checking account; third instructions for obtaining data from the account holder indicative of a desire by the account holder to make a new payment from the checking account and data indicative of the identifier; and fourth instructions for scheduling the new payment from the first account.

In some embodiments of the present invention, an apparatus for facilitating a payment may include means for obtaining data indicative of a first financial account associated with an account holder; means for identifying if the first financial account has previously been used to make a payment to a second financial account, the second financial account being associated with the account holder; and means for scheduling a payment from the first financial account to the second financial account if the first financial account has previously been used to make a payment to a second financial account. In some other embodiments, an apparatus for facilitating a payment may include means for obtaining data indicative of an account holder making a first payment from a first financial account to a second financial account, the first financial account and the second financial account being associated with the account holder; means for obtaining data indicative of a desire by the account holder to make a new payment from the first financial account to the second financial account; and means for scheduling the new payment from the first financial account to the second financial account. In some additional embodiments, an apparatus for facilitating a payment may include means for obtaining a payment by an account holder, the payment being drawn from a checking account associated with the account holder; means for identifying from the payment an identifier indicative of the checking account; means for obtaining data from the account holder indicative of a desire by the account holder to make a new payment from the checking account and data indicative of the identifier; and means for scheduling the new payment from the first account. In some further embodiments, an apparatus for facilitating a payment may include means for obtaining a payment by an account holder, the payment being drawn from a checking account associated with the account holder; means for identifying from the payment an identifier indicative of the checking account; means for obtaining data from the account holder indicative of a desire by the account holder to make a new payment from the checking account and data indicative of the identifier; and means for scheduling the new payment from the first account.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components for an embodiment of an apparatus usable with the present invention;

FIG. 2 is another block diagram of system components for an embodiment of an apparatus usable with the present invention;

FIG. 3 is a flowchart of a first embodiment of a method in accordance with the present invention;

FIG. 4 is a flowchart of a second embodiment of a method in accordance with the present invention;

FIG. 5 is a flowchart of a third embodiment of a method in accordance with the present invention;

FIG. 6 is a flowchart of a fourth embodiment of a method in accordance with the present invention;

FIG. 7 is a block diagram of components for an embodiment of a the server of FIGS. 1 and 2;

FIG. 8 is a representation of an interface that may be used with the present invention;

FIG. 9 is another representation of an interface that may be used with the present invention;

FIG. 10 is another representation of an interface that may be used with the present invention;

FIG. 11 is another representation of an interface that may be used with the present invention;

FIG. 12 is another representation of an interface that may be used with the present invention; FIG. 13 is an illustration of a representative account information database of FIG. 7;

FIG. 14 is an illustration of a representative account holder information database of FIG. 7; and

FIG. 15 is an illustration of a representative payment information database of FIG. 7,

### DETAILED DESCRIPTION

Applicants have recognized that there is a market opportunity for systems, means, computer code and methods for facilitating a payment from an account. According to some embodiments of the present invention, a party or device may receive information indicative of a first account (e.g., a checking account) associated with an account holder. The party or device may receive the information direction or indirectly from the account holder (e.g., the account holder may provide the information via a Web site), from a database, as part of an email message or other communication, etc. The party or device may then determine if the account holder has used the first account in the past (or within a designated time period) to make a payment to another account, a payee, etc. For example, suppose an account holder has a checking account via a bank and a credit card account via a credit card issuer. The party or device may determine if the account holder has used the checking account to make a payment towards the credit card account's balance within the previous six months. If the answer is “yes”, the party or device may then allow the account holder to schedule a new payment from the checking account to the credit card account. In some embodiments, the party or device may then facilitate or conduct the actual payment transaction or provide information regarding the scheduled payment to another party or entity that may facilitate or conduct the actual payment transaction. Facilitation and processing of the payment may involve other checks of the checking account and/or the account holder (e.g., making sure the checking account is still valid, making sure that the account holder is able to make the payment, making sure that the checking account has sufficient funds for the transaction, etc.). These and other features will be discussed in further detail below, by describing a system, individual devices, and processes according to embodiments of the invention.

System

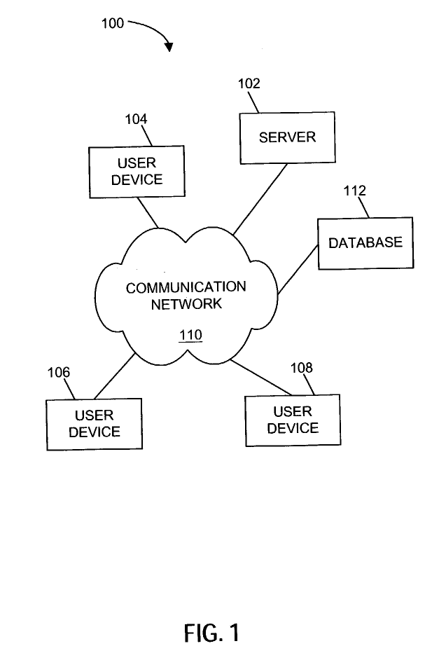

Now referring to FIG. 1, a first embodiment 100 of an apparatus or system usable in embodiments of the present invention is illustrated. In some embodiments the apparatus 100 may include a server 102 in direct or indirect communication with one or more user or client devices 104, 106, 108 via a computer, data, or communications network 110. In some embodiments, the apparatus 100 also may include one or more databases 112 (which may be part of or included in the server 102). In some embodiments, the server 102 may comprise or include a single device or computer, a networked set or group of devices or computers, a workstation, etc.

In some embodiments, the server 102 may implement or host a Web site or other resource. An account holder may access the Web site or resource to provide or otherwise authorize payment for a bill, order, statement, purchase, transaction, etc. For example, the server 102 may provide a Web site or automated telephone system that allows the account holder to provide, indicate, or select information regarding an account the account holder wishes to use to pay a bill, make or schedule a payment, provide payment to another account, etc. Upon receiving information from the account holder, the server 102 may verify that the account holder has used the account before and facilitate scheduling of a payment, as will be discussed in more detail below. In some embodiments, the server 102 may then facilitate or conduct the actual payment transaction or provide information regarding the scheduled payment to another party or device (not shown in FIG. 1) that may facilitate or conduct the actual payment transaction.

In some embodiments, information regarding one or more account holders and/or one or more accounts may be stored in, or accessed from, an account holder information database and/or an account device information database.

The user or client devices 104, 106, 108 preferably allow account holders or other entities to interact with the server 102 and the remainder of the apparatus 100 and/or other devices connected to the communications network 110. A user device also may enable a user to access Web sites, software, databases, etc. hosted or operated by the server 102. If desired, the user devices also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

Many different types of implementations or hardware configurations can be used in the system 100 and with the methods disclosed herein and the methods disclosed herein are not limited to any specific hardware configuration for the system 100 or any of its components. The devices shown in FIG. 1 need not be in constant communication. For example, a user device may communicate with the server 102 only when such communication is appropriate or necessary.

The communications network 110 might be or include the Internet, the World Wide Web, or some other public or private computer, cable, telephone, client/server, peer-to-peer, or communications network or intranet, as will be described in further detail below. The communications network 110 illustrated in FIG. 1 is meant only to be generally representative of cable, computer, telephone, peer-to-peer or other communication networks for purposes of elaboration and explanation of the present invention and other devices, networks, etc. may be connected to the communications network 110 without departing from the scope of the present invention. The communications network 110 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to the server 102 without departing from the scope of the present invention. Moreover, as used herein, communications include those enabled by wired or wireless technology.

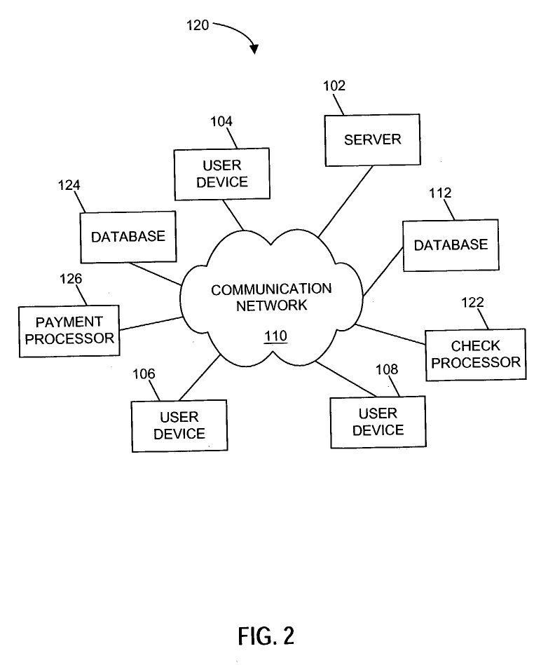

Now referring to FIG. 2, another embodiment 120 of an apparatus or system usable in embodiments of the present invention is illustrated. The system 120 may include some or all of the devices illustrated in FIG. 1. In addition, the system 120 may include a check or other payment processor device 122 that receives checks or other payments from one or more account holders or is used to process such checks or other payments. For example, a card (e.g., credit card, private label card) issuer or manager may issue statements to account holders. The accounts holders may then provide payments by check, money order, or other mechanism to the card issuer or manager. The card issuer or manager may process the checks, money orders, etc. with or using the check processor device 122. In some embodiments, the check processor device 122 may scan a check, money order, etc. received from an account holder or otherwise determine information from the check, money order, etc. and associate the information with the account holder. For example, the check processor device 122 may determine an ABA (American Banking Association) number, account number, account holder name, account holder address, statement number, bill number, etc. associated with a payment. The check processor device 122 may store some or all of such information regarding one or more account holders in a database 124, some or all of which also may be stored in the database 112, and/ provide some or all of such information to the server 102.

In some embodiments, the system 120 may include a payment processor device 126 that may be used in conducting a payment from an account holder's account once the payment has been scheduled by the server 102. For example, the server 102 may host a Web site on which an account holder can schedule a payment from an account (e.g., a checking account) associated with the account holder. The payment may be made to a second account associated with the account holder (e.g., a credit card account, a private label card account), to a payee designated by the account holder, etc. Once the account holder has scheduled the payment via the server 102, the server 102 may forward or provide the information to the payment processor 126 to conduct the actual payment transaction. The payment processor 126 may be operated by or for an entity that specializes in such transactions, that has access to the Automated Clearing House (ACH) network, etc.

Process Description

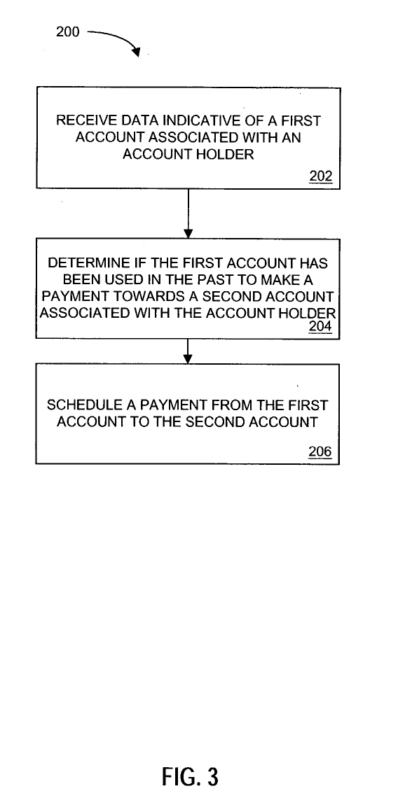

Reference is now made to FIG. 3, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. In some embodiments, some or all of the steps of the method 200 may be performed or completed by a server 102, as will be discussed in more detail below. The method 200 is particularly well suited for applications where an account holder wants to schedule a payment from a first account to a second account. For example, suppose the account holder has a checking account (i.e., the first account) and a credit card account (i.e., the second account). The account holder may receive a statement or bill from the issuer of the credit card account. The method 200 allows the account holder to schedule payment for all or a portion of the bill for the second account using the first account or otherwise allows the account holder to schedule a payment from the first account to the second account.

Processing begins at a step 202 during which the server 102 receives data indicative of a first account associated with an account holder. The first account may be any type of financial account, such as a checking account, saving account, money market account, line of credit account, etc.

In some embodiments, the server 102 may receive the data directly or indirectly from the account holder. For example, in some embodiments, the server 102 might receive the data in an email message sent by the account holder, in an XML transfer conducted on behalf of the account holder, via a Web site or automated telephone system accessed by the account holder and at which the account holder provides the data, from the results of a database query or information retrieval, etc.

The information received during the step 202 may include information associated with the first account such as, for example, an ABA (American Banking Association) number associated with a bank that is providing the account, a number or other identifier associated with the account (e.g., a checking account number, a credit card number), a number or other identifier associated with the account holder, a check number, etc.

During a step 204, the server 102 determines if the first account has been used in the past to make a payment towards a second account associated with the account holder. Thus, in some embodiments, the step 204 may be used to verify the existence of the first account or the availability of the first account. For example, the server 102 may query a database (e.g., the database 112) to determine if the account holder has ever used to the first account to make a payment to the second account. If the answer is “no”, the method 200 may terminate. If the answer is “yes” the server 102 may continue to allow the account holder to schedule a payment from the first account to the second account. The second account might be a credit card or debit card account, bank card account, store account, line of credit account, etc. In some embodiments, the second account might be an account associated with a merchant, such as a private label card account, that is provided to the account holder by the merchant, by a card issuer in conjunction with the merchant, etc.

As another example, the server 102 may receive information from another entity or device (e.g., the check processor 122) that indicates what accounts one or more account holders have used in the past to make payments towards other accounts. As a more specific example, the check processor 122 may provide information to the server 102 regarding one or more ABA numbers and/or account numbers used by an account holder to make one or more payments to one or more other accounts. The check processor 122 also may provide account numbers, ABA numbers, credit card account numbers, or other appropriate information related to the second account. For purposes of the method 200, both the first account and the second account are associated with the same account holder. However, in other embodiments, the second account may not be associated with the account holder. For example, the account holder may use a checking account associated with the account holder to make a payment towards another person's bill or credit card account balance.

During a step 206, the server 102 schedules a payment from the first account to the second account or otherwise facilitates scheduling of the payment. For example, an account holder may want to use a checking account (i.e., the first account) to make a payment towards the balance on a credit card associated with the account holder (i.e., the second account). The account holder may communicate with the server 102 (e.g., by accessing a Web site operated by the server 102) to indicate when the payment is to be made, the amount of the payment, the account (i.e., the first account) the payment is to be made from, the account (i.e., the second account) the payment is to be made to, etc.

In some embodiments, the server 102 may schedule the payment during the step 206, only if the account owner has used the first account in the past (or during a previously designated period of time) to make a payment to the second account. Thus, the account holder's payment history for an account is used to determine if a new payment from the first account to the second account can be scheduled.

In some embodiments, the account holder may have had to use the first account to make a payment to the second account within a designated time period. For example, if the server 102 might not allow or facilitate scheduling of a payment from the first account to the second account if the account holder has not within the previous six months used the first account to make a payment to the second account. Thus, the method 200 may include establishing or otherwise determining a time period to use and making the appropriate determination during the step 204.

In some embodiments, the party operating the server 102 also may be the party operating the check processor 122 or otherwise receiving payments (e.g., checks, wire transfers) from account holders. The server 102 may be involved in the payment receiving process so as to obtain the information it needs for the step 204.

In some embodiments, after the step 206, the server 102 may provide data indicative of the scheduled payment to another party or device that actually may process the payment transaction from the first account to the second account. The other party or device may conduct such transaction via the ACH network or other system, network, etc. In addition, the other party or device may deny the transaction is sufficient funds do not exist in the first account, the first account is invalid, the party or devices determines or believes that the transaction may be fraudulent, is not OFAC (Office of Foreign Assets Control) compliant, etc. The server 102 may receive data indicative of a completion, delay, return, processing, rescheduling, or denial of the payment transaction scheduled during the step 206.

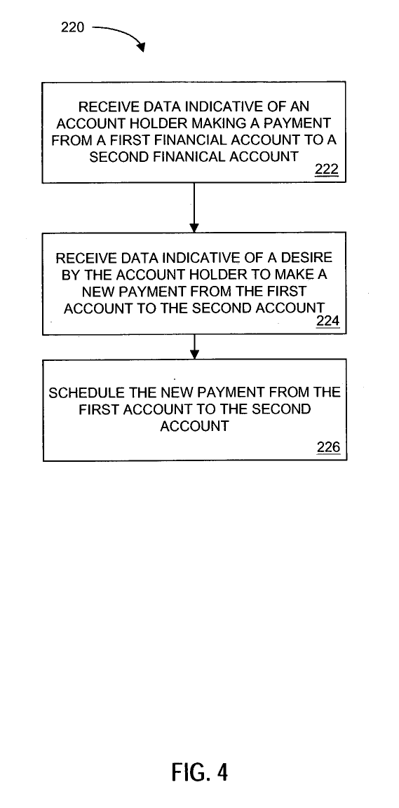

Reference is now made to FIG. 4, where a flow chart 220 is shown which represents the operation of a second embodiment of the present invention. The particular arrangement of elements in the flow chart 220 is not meant to imply a fixed order to the steps; embodiments of the present invention can be practiced in any order that is practicable. In some embodiments, some or all of the steps of the method 220 may be performed or completed by the server 102, as will be discussed in more detail below. In some embodiments, the method 220 may include some or all of the variations discussed above in regard to the method 200. The method 220 is particularly well suited for applications where an account holder wants to schedule a payment from a first account to a second account.

Processing begins at a step 222 during which the server 102 receives data indicative of an account holder making a payment from a first account to a second account. For example, the server 102 may receive such data from the check processor 122 or some other device or entity. The data received during the step 222 may include data regarding one or more ABA numbers and/or account numbers used by the account holder to make a payment to the second account, ABA numbers, credit card account numbers, or other appropriate information related to the second account; etc.

During a step 224, the server 102 receives data indicative of a desire by the account holder to make a new payment from the first account to the second account. As previously discussed above, the server 102 may receive such data directly or indirectly from the account holder.

During a step 226, the server 102 schedules a payment from the first account to the second account. The step 226 is similar to the step 206 previously discussed above.

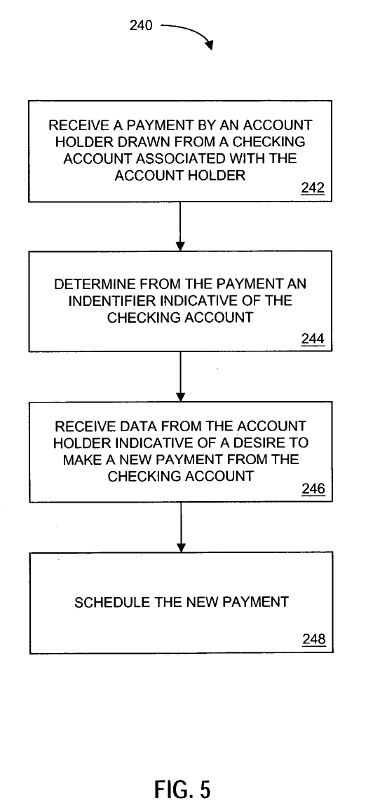

Reference is now made to FIG. 5, where a flow chart 240 is shown which represents the operation of a third embodiment of the present invention. The particular arrangement of elements in the flow chart 240 is not meant to imply a fixed order to the steps; embodiments of the present invention can be practiced in any order that is practicable. In some embodiments, the method 240 may include some or all of the variations discussed above in regard to the method 200. The method 240 is particularly well suited for applications where an account holder wants to schedule a payment from a first account to a second account.

Processing begins at a step 242 during which the server 102 receives a payment by an account holder drawn from a checking account associated with the account holder. For example, the account holder may have sent in a check to pay for a bill or pay down a balance or other debt.

During a step 244, the server 102 determines an identifier indicative of the checking account. For example, the server 102 may determine an ABA number and/or an account number associated with the checking account and use one or both as the identifier.

During a step 246, the server 102 receives data indicative of a desire by the account holder to make a new payment from the first account. As previously discussed above, the server 102 may receive such data directly or indirectly from the account holder.

During a step 248, the server 102 schedules a new payment from the first account. The step 248 is similar to the step 206 previously discussed above.

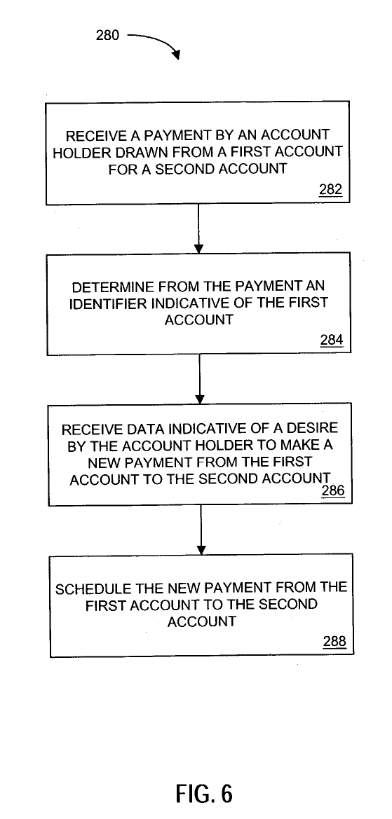

Reference is now made to FIG. 6, where a flow chart 280 is shown which represents the operation of a fourth embodiment of the present invention. The particular arrangement of elements in the flow chart 280 is not meant to imply a fixed order to the steps; embodiments of the present invention can be practiced in any order that is practicable. In some embodiments, some or all of the steps of the method 280 may be performed or completed by the server 102, as will be discussed in more detail below. In some embodiments, the method 280 may include some or all of the variations discussed above in regard to the method 200. The method 280 is particularly well suited for applications where an account holder wants to schedule a payment from a first account to a second account.

Processing begins at a step 282 during which the server 102 receives a payment by an account holder drawn from a first account to be applied to a second account. For example, the account holder may have sent in a check to pay for a bill or pay down a balance or other debt. The second account may or may not be associated with the account holder.

During a step 284, the server determines from the payment an identifier indicative of the first account (e.g., an account number, an ABA number). The step 284 is similar to the step 244 previously discussed above.

During a step 286, the server 102 receives data indicative of a desire by the account holder to make a new payment from the first account. As previously discussed above, the server 102 may receive such data directly or indirectly from the account holder.

During a step 288, the server 102 schedules a new payment from the first account to the second account. The step 288 is similar to the step 206 previously discussed above.

Server

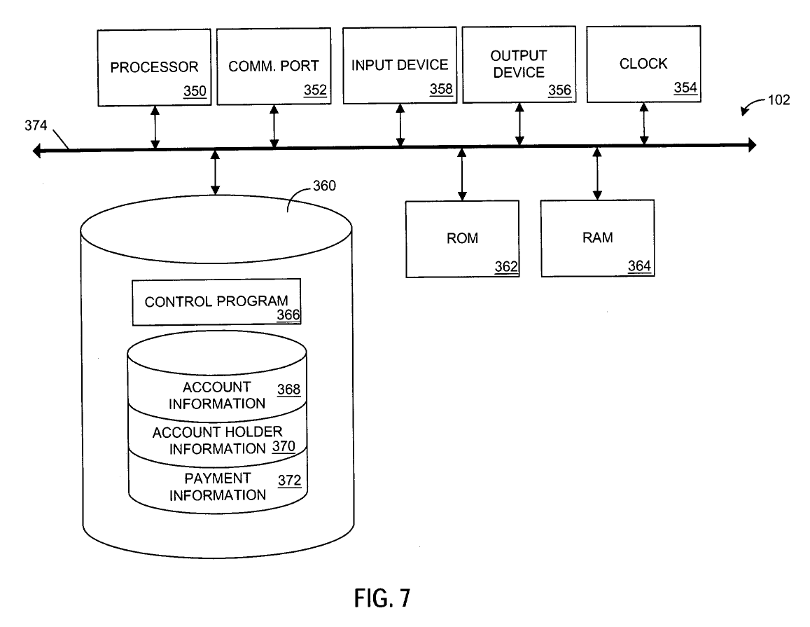

Now referring to FIG. 7, a representative block diagram of a server or controller 102 is illustrated. The server 102 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The server 102 also may include an internal clock element 354 to maintain an accurate time and date for the server 102, create time stamps for communications received or sent by the server 102, etc.

If desired, the server 102 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 102 may include a memory or data storage device 360 to store information, software, databases, communications, device drivers, payments, etc. The memory or data storage device 360 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 102 also may include separate ROM 362 and RAM 364.

The processor 350 and the data storage device 360 in the server 102 each may be, for example: (i) located entirely within a single computer or other computing device; or (ii) connected to each other by a remote communication medium, such as a serial port cable, telephone line or radio frequency transceiver. In one embodiment, the server 102 may comprise one or more computers that are connected to a remote server computer for maintaining databases.

A conventional personal computer or workstation with sufficient memory and processing capability may be used as the server 102. In one embodiment, the server 102 operates as or includes a Web server for an Internet environment. The server 102 preferably is capable of high volume transaction processing, performing a significant number of mathematical calculations in processing communications and database searches. A Pentium™ microprocessor manufactured by Intel Corporation may be used for the processor 350. Equivalent and other processors are available from Motorola, Inc., AMD, or Sun Microsystems, Inc. The processor 350 also may comprise one or more microprocessors, computers, computer systems, etc.

Software may be resident and operating or operational on the server 102. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The server 102 also may include or store information regarding account holders, payees, accounts, payments, communications, etc. For example, information regarding one or more accounts may be stored in an account information database 368 for use by the server 102 or another device or entity. Information regarding one or more account holders may be stored in an account holder information database 370 for use by the server 102 or another device or entity and information regarding one or more payments may be stored in a payment information database 372 for use by the server 102 or another device or entity. In some embodiments, some or all of one or more of the databases may be stored or mirrored remotely from the server 102.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware/hardware configurations for the server 102 have been illustrated, it should be noted that other implementations and hardware configurations are possible and that no specific implementation or hardware/software configuration is needed. Thus, not all of the components illustrated in FIG. 7 may be needed for a server implementing the methods disclosed herein.

User Device

As mentioned above, a user device may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device 102 may have the same structure or configuration as the server 102 illustrated in FIG. 7 and include some or all of the components of the server 102.

Interfaces

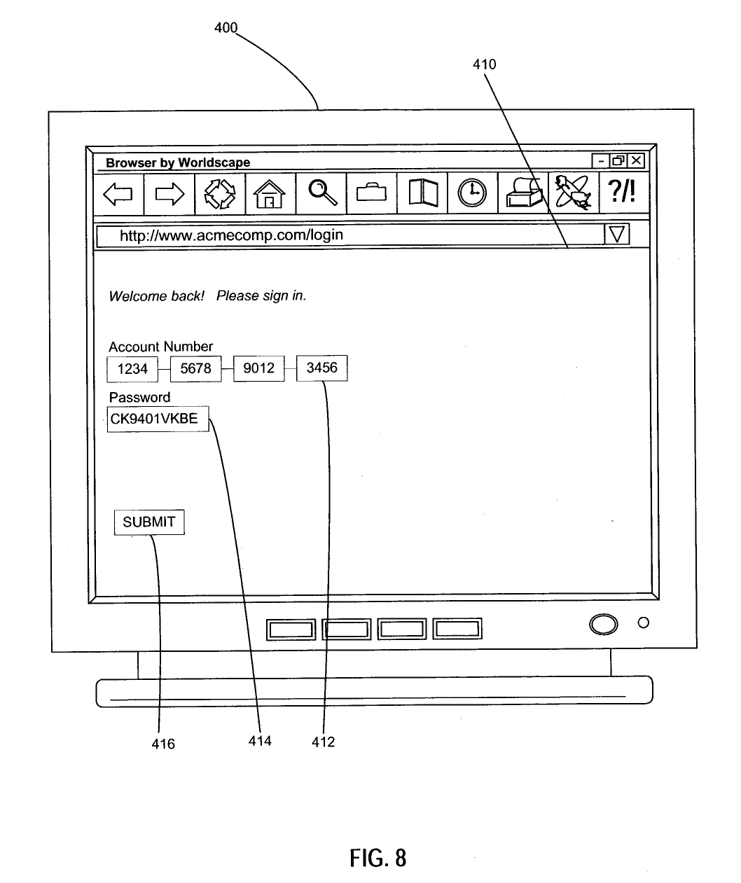

As previously discussed above, in some embodiments the server 102 may implement, display, or provide one or more interfaces that an account holder can access or use to schedule a payment from an account. Now referring to FIG. 8, an account holder might use a display or monitor 400 (which may be part of a user device) to view an interface 410 to gain entry to a payment scheduling system. The interface 410 may require the account holder to provide an account number, login, etc. and/or a password in text blocks 412, 414, respectively. In some embodiments, the account number entered into the text block 412 may be the account number of an account (e.g., a credit card account) to which the account owner wants to make a payment. After the account holder has provided the appropriate information, the account holder may click on or select a SUBMIT button 416 to continue.

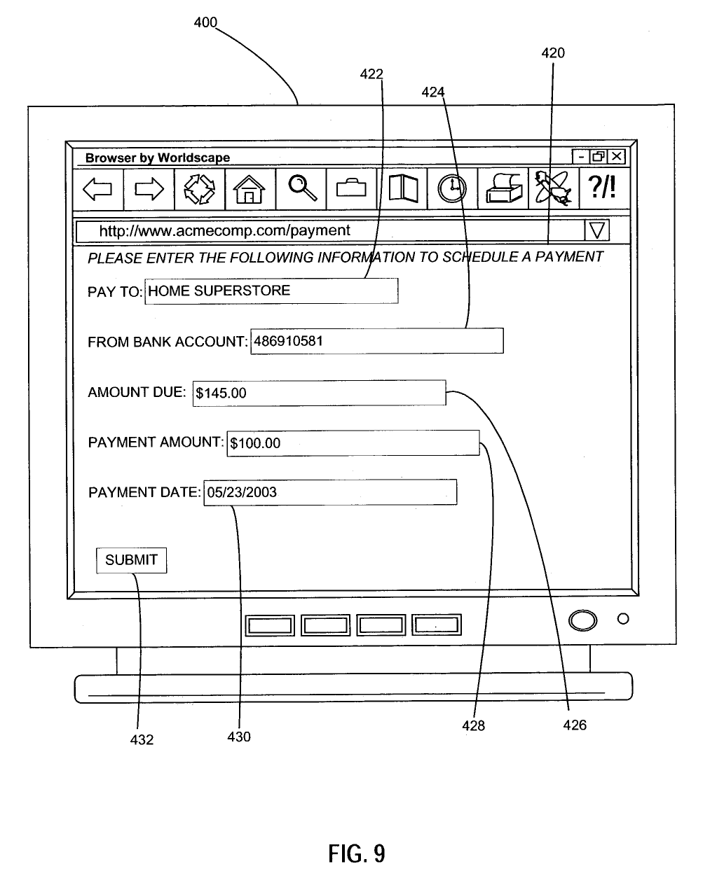

Now referring to FIG. 9, an interface 420 is illustrated that the account holder may use to provide information regarding a payment the account holder desires to make. The interface 420 may include text blocks 422 and 424 into which the account holder can enter, indicate or select the payee (which may be by name, account number, etc.) of the payment and an identifier for the account the account holder wishes to use to make the payment. Once the account holder indicates the payee in the text block 422, the server 102 may be able to indicate the minimum or total amount due to the payee by the account holder in block 426 or the account holder may enter the information. The account holder may indicate in text block 428 the amount the account holder wishes to pay to the payee from the account indicated in the block 424. In addition, the account holder may indicate in text block 430 the date the account wants the payment to be processed, transacted, completed, etc. Once the account holder has provided the appropriate information, the account holder may click on or select a SUBMIT button 432 to continue.

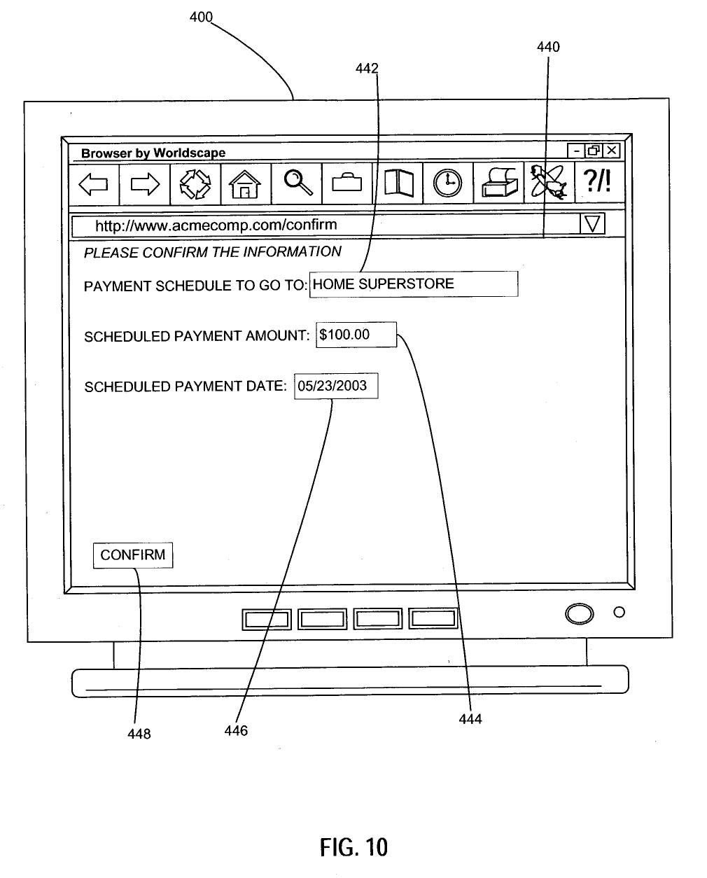

Now referring to FIG. 10, an interface 440 is illustrated that the server 102 may provide in order to confirm the payee (in text block 442), payment amount (in text block 446), and payment date (in text block 446) information previously provided by the account holder. Once the account holder is satisfied with the information, the account holder may click on or select a SUBMIT button 448 to continue. If the account holder tries to change any of the information in the blocks 442, 444, or 446, the account holder may be returned to the interface 420.

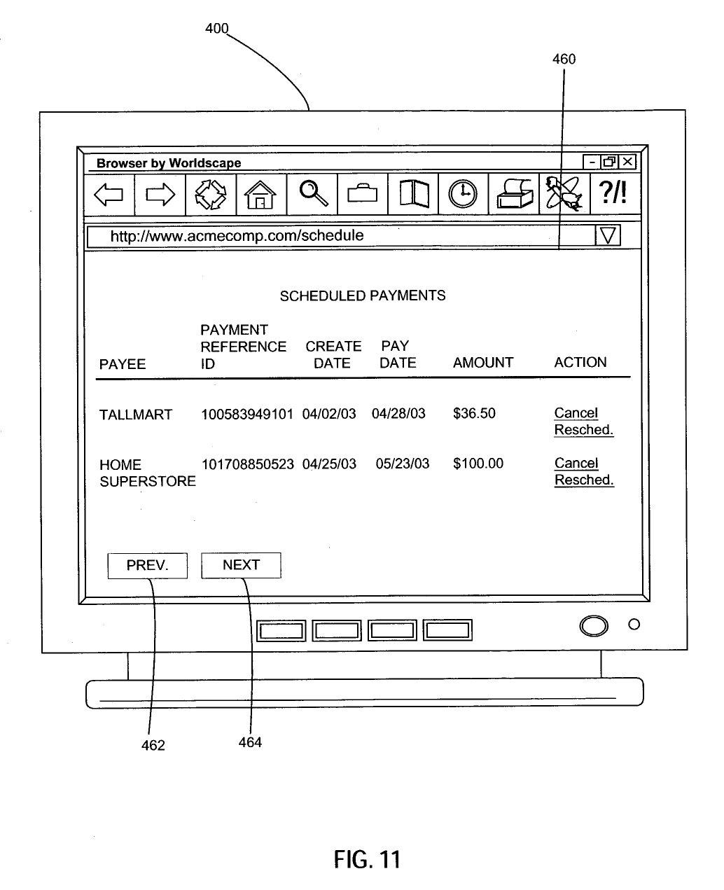

Now referring to FIG. 11, an interface 460 is illustrated that the server 102 may provide in order to give an account holder a list of upcoming payments scheduled by the account holder. While not illustrated in the interface 460, the interface 460 also might illustrate the accounts used to make each of the payments. If desired, the account holder can cancel or reschedule a previously scheduled payment by clicking on or selecting the appropriate link “Cancel” or “Resched.”. If the account holder wants to go back to the previously viewed interface page, the account holder and select PREV. button 462. Similarly, the account holder go select NEXT button 464 to move to the next interface page.

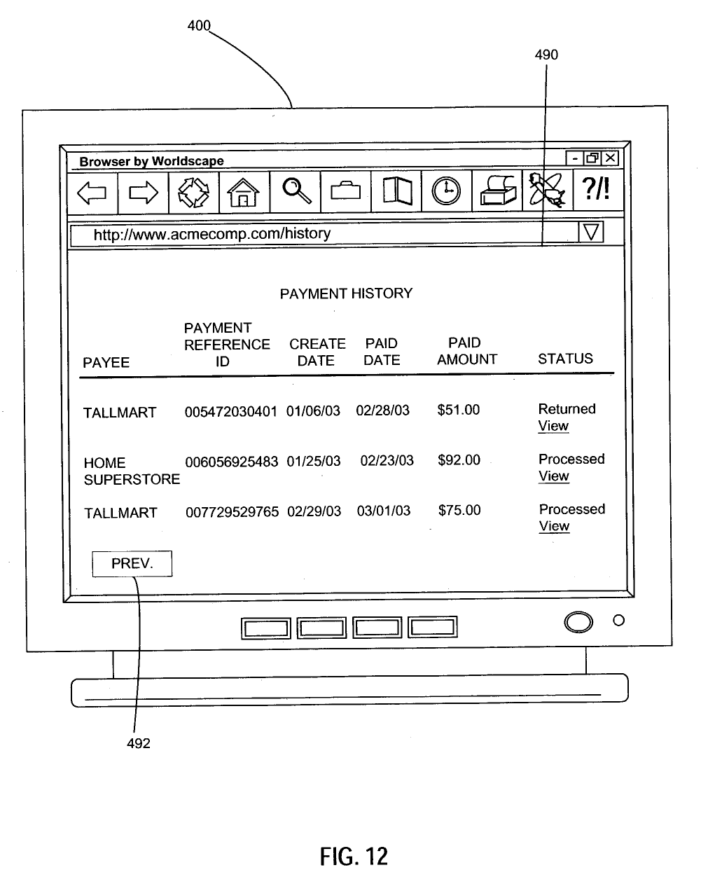

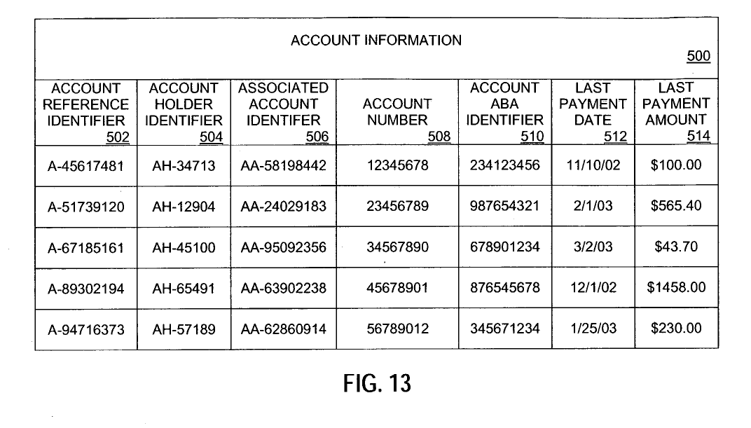

Now referring to FIG. 12, an interface 490 is illustrated that the server 102 may provide in other to give an account holder a status of previously scheduled and/or made payments. The status may indicate whether or not a payment has been processed, canceled, denied, returned (e.g., as if a check bounces or is not honored), delayed, etc. If the account holder wants to go back to the previously viewed interface page, the account holder and select PREV. button 492.

Databases

As previously discussed above, in some embodiments a server, user device, or other device may include or access an account information database for storing or keeping information regarding one or more account. One representative account information database 500 is illustrated in FIG. 13. For purposes of illustration, but not limitation, the account information database 500 is assumed to include information regarding checking accounts used by account holders to make payments to other accounts (e.g., credit card accounts).

The account information database 500 may include an account identifier field 502 that may include codes or other identifiers for one or more accounts, an account holder identifier field 504 that may include codes or other identifiers for one or more account holders, an associated account identifier field 506 that may include codes or other identifiers of other accounts (e.g., the credit card accounts) associated with the account holders identified in the field 504, an account number field 508 that may include codes or other identifiers for checking accounts associated with the account reference numbers identified in the field 502 and the account holders identified in the field 504, an account ABA identifier field 510 that may include the ABA numbers for the checking accounts identified in the field 508, a last payment date field 512 that may include information regarding the last time a checking account identified in the field 508 was used to make a payment to a credit card account identified in the field 506 (both of which being associated with the appropriate account holder in the field 504), and a last payment amount field 514 that may include information regarding the payment amounts for the payments made on the dates indicated in the field 512.

Other or different fields also may be used in the account information database 500. For example, in some embodiments an account information database may include information regarding the balances of accounts, previous payments made for accounts, how the payments were made, the creation dates of the accounts, any problems (e.g., missed or late payments) associated with the accounts, etc.

As illustrated by the account information database 500 of FIG. 13, the account identified as “A-67185161” in the field 502 is associated with the account holder identified as “AH-45100”. The account holder “AH-45100” has another account (i.e., a credit card account in this example) identified as “AA-95092356”. The account “A-67185161” is a checking account having an associated account number “34567890” and an associated ABA number “678901234”. In addition, the account “A-67185161” was last used to make a payment to the credit card account identified as “AA-95092356” on Mar. 2, 2003, in the amount of 43.70. Information regarding the accounts identified in the field 506 also may be stored in the database 500 or may be stored in a different database.

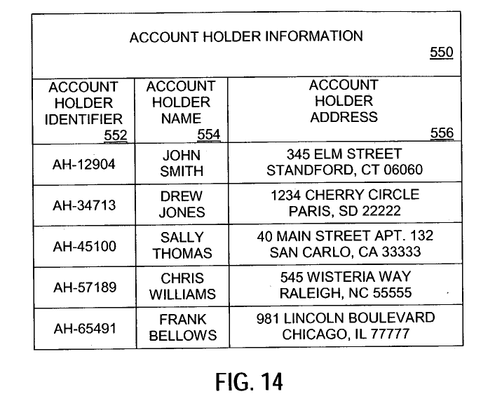

As previously discussed above, in some embodiments a server, user device, or other device may include or access an account holder database for storing or keeping information regarding one or more account holders. One representative account holder information database 550 is illustrated in FIG. 14.

The account holder information database 550 may include an account holder identifier field 552 that may include codes or other identifiers for one or more account holders, an account holder name field 554 that may include names or other identifying information for the account holders identified in the field 552, and an account holder address field 556 that may include address and/or other contact information (e.g., telephone numbers, email addresses, facsimile numbers) for the account holders identified in the field 552. As illustrated by the account holder information database 550 of FIG. 14, the account holder identified as “AH-45100” in the field 552 is named “SALLY THOMAS” and has an address of “40 MAIN STREET, APT. 132 SAN CARLO, CA 33333”.

Other or different fields also may be used in the account holder information database 550. For example, in some embodiments an account holder information database may include information regarding the age, gender, employment history, credit history, education, marital status, preferences, hobbies, etc., of the account holders.

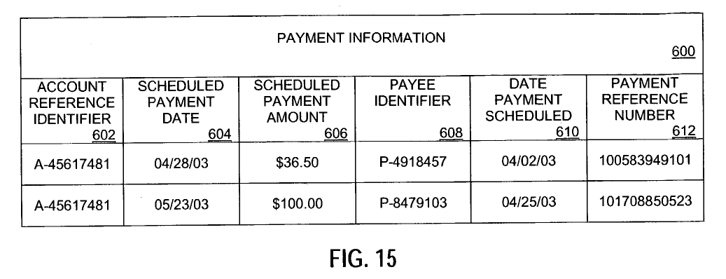

As previously discussed above, in some embodiments a server, user device, or other device may include or access a payment information database for storing or keeping information regarding one or more scheduled payments. One representative payment information database 600 is illustrated in FIG. 15. For purposes of ease of explanation, the payment information database 600 illustrated in FIG. 15 references only the scheduled payments illustrated in the Web page 460 of FIG. 11.

The payment information database 600 may include an account reference identifier field 602 that may include codes or other identifiers for accounts associated with one or more scheduled payments, a scheduled payment date field 604 that may include information regarding the dates that payments are scheduled to be made for the accounts referenced in the field 602, a scheduled payment amount field 606 that may include information regarding the amounts of payments scheduled, a payee identifier field 608 that may include codes or other identifiers for payees or receivers of the scheduled payments, a date payment scheduled field 610 that may include information regarding the date a payment is scheduled (which should always be earlier than or the same day as the date of the scheduled payment reflected in the field 604), and a payment reference number field 612 that may include codes or other identifiers associated with scheduled payments.

Other or different fields also may be used in the payment information database 600. For example, in some embodiments a payment information database may include information regarding the actual accounts being used to make the payments, the status of the payments, the names of payees, etc.

As illustrated by the payment information database 600 of FIG. 15, the account identified as “A-45617481” in the field 602 currently has two payments scheduled, one in the amount of $36.50 to be paid on Apr. 28, 2003, and one in the amount of $100.00 to be paid on May 23, 2003. The first payment of $36.50 was scheduled on Apr. 2, 2003, is to be paid to the payee identified as “P-4918457” (which may be “TALLMART”), and has a payment reference number of “100583949101”. The second payment of $100.00 was scheduled on Apr. 25, 2003, is to be paid to the payee identified as “P-8479103” (which may be “HOME SUPERSTORE”), and has a payment reference number of “101708850523”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating payment, comprising:
receiving data indicative of a first financial account associated with an account holder;
determining if said first financial account has previously been used to make a payment to a second financial account, said second financial account being associated with said account holder; and
scheduling a payment from said first financial account to said second financial account if said first financial account has previously been used to make a payment to a second financial account.

2. The method of claim 1, wherein said receiving data indicative of a first financial account associated with an account holder includes receiving said data from said account holder.

3. The method of claim 2, wherein said receiving said data from said account holder includes receiving said data via a Web site accessed by said account holder.

4. The method of claim 1, wherein said determining if said first financial account has previously been used to make a payment to a second financial account includes determining if said first financial account has previously been used to make a payment to said second financial account within a designated time period.

5. The method of claim 4, further comprising:
determining said designated time period.

6. The method of claim 4, wherein scheduling a payment from said first financial account to said second financial account if said first financial account has previously been used to make a payment to a second financial account occurs only if said if said first financial account has previously been used to make a payment to said second financial account within said designated time period.

7. The method of claim 1, wherein said first financial account is a checking account.

8. The method of claim 1, wherein said second financial account is a credit card account.

9. The method of claim 1, wherein said second financial account is a private label credit card account.

10. The method of claim 1, wherein said second financial account is associated with a merchant.

11. The method of claim 1, further comprising:
receiving data indicative of said second financial account from said account holder.

12. The method of claim 1, further comprising:
receiving data indicative of at least one previous payment made to said second account.

13. The method of claim 12, wherein said at least one previous payment made to said second account was made from said first financial account.

14. The method of claim 13, wherein said first financial account is a checking account.

15. The method of claim 1, further comprising:
providing data indicative of said payment.

16. The method of claim 1, further comprising:
receiving a first payment from said first financial account to said second financial account.

17. The method of claim 16, wherein said first financial account is a checking account and said first payment is made by check.

18. The method of claim 17, determining from said check an account number associated with said first financial account and said account holder.

19. The method of claim 18, wherein said receiving data indicative of a first financial account associated with an account holder includes receiving said account number.

20. A method for facilitating payment, comprising:
receiving data indicative of an account holder making a first payment from a first financial account to a second financial account, said first financial account and said second financial account being associated with said account holder;
receiving data indicative of a desire by said account holder to make a new payment from said first financial account to said second financial account; and
scheduling said new payment from said first financial account to said second financial account.

21. The method of claim 20, further comprising:
providing data indicative of said new payment to a party capable of processing said new payment.

22. The method of claim 20, wherein said second financial account is associated with a merchant.

23. The method of claim 20, wherein said first financial account is a checking account.

24. A method for facilitating a payment, comprising:
receiving a payment by an account holder, said payment being drawn from a checking account associated with said account holder;
determining from said payment an identifier indicative of said checking account;
receiving data from said account holder indicative of a desire by said account holder to make a new payment from said checking account and data indicative of said identifier; and
scheduling said new payment from said first account.

25. The method of claim 24, wherein said payment is made from said checking account to a second account associated with said account holder.

25. The method of claim 24, wherein said second account is associated with a merchant.

25. The method of claim 24, wherein said scheduling said new payment from said first account includes scheduling a payment from said first account to a second account, said second account being associated with said account holder.

28. A method for facilitating a payment, comprising:
receiving a payment by an account holder, said payment being drawn from a first account associated with said account holder for a second account associated with said account holder;
determining from said payment an identifier indicative of said first account;
receiving data from said account holder indicative of a desire by said account holder to make a new payment from said first account and data indicative of said identifier; and
scheduling said new payment from said first account to said second account.

29. A system for facilitating a payment, comprising:
a memory;
a communication port; and
a processor connected to said memory and said communication port, said processor being operative to:
receive data indicative of a first financial account associated with an account holder;
determine if said first financial account has previously been used to make a payment to a second financial account, said second financial account being associated with said account holder; and
schedule a payment from said first financial account to said second financial account if said first financial account has previously been used to make a payment to a second financial account.

30. A computer program product in a computer readable medium for facilitating a payment, comprising:
first instructions for obtaining data indicative of a first financial account associated with an account holder;
second instructions for identifying if said first financial account has previously been used to make a payment to a second financial account, said second financial account being associated with said account holder; and
third instructions for scheduling a payment from said first financial account to said second financial account if said first financial account has previously been used to make a payment to a second financial account.
